(19) United States
(12) Patent Application Publication
(10) Pub. No.: US 2023/0420871 A1
(43) Pub. Date: Dec. 28, 2023

(54) COAXIAL CABLE CLAMPING MEMBER

(71) Applicant: Yazaki Corporation, Tokyo (JP)

(72) Inventor: Tohru AOKI, Shizuoka (JP)

(73) Assignee: Yazaki Corporation, Tokyo (JP)

(21) Appl. No.: 18/465,644

(22) Filed: Sep. 12, 2023

Related U.S. Application Data
(63) Continuation of application No. PCT/JP2022/038854, filed on Oct. 19, 2022.

(30) Foreign Application Priority Data
Nov. 16, 2021 (JP) 2021-186423

(51) Int. Cl. H01R 4/2437

(52) U.S. Cl. CPC H01R 4/2437

(57) ABSTRACT

A coaxial cable clamping member includes a clamping main body that is capable of clamping a coaxial cable and a pressure contact blade that is fixed to the clamping main body and is capable of being connected to an outer conductor of the coaxial cable. Further, the coaxial cable clamping member includes a grounding portion that is fixed to the clamping main body under a state in which grounding portion is electrically coupled to the pressure contact blade and is capable of grounding the outer conductor of the coaxial cable to a grounded portion. The clamping main body is configured to clamp a plurality of coaxial cables. Under a state in which the clamping main body clamps the plurality of coaxial cables, the outer conductors of all the plurality of coaxial cables clamped by the clamping main body are electrically connected to the grounding portion via the pressure contact blade.

### CROSS-REFERENCE TO RELATED APPLICATIONS

The present application is a continuation of International Application No. PCT/JP2022/038854, filed on Oct. 19, 2022, and based upon and claims the benefit of priority from Japanese Patent Application No. 2021-186423, filed on Nov. 16, 2021, the entire contents of which are incorporated herein by reference.

### TECHNICAL FIELD

The present application relates to a coaxial cable clamping member.

### BACKGROUND

In Japanese Patent No. 6792286, a cable clamp that clamps a coaxial cable includes a pair of insulation grips. Further, when the pair of insulation grips are crimped onto an insulation sheath of the coaxial cable, a blade formed on the pair of insulation grips penetrates the insulation sheath, and is brought into contact with an external conductor. In this manner, the external conductor of the coaxial cable can be grounded to a grounded portion such as a ground pattern of a printed circuit board via the blade.

### SUMMARY OF THE INVENTION

However, the related art described above adopts a structure in which the cable clamp clamps one coaxial cable, and hence grounding of external conductors of a plurality of coaxial cables requires a time-consuming process.

An object of the present application is to provide a coaxial cable clamping member capable of grounding a plurality of coaxial cables more easily.

A coaxial cable clamping member according to the present application includes a clamping main body capable of clamping a coaxial cable, a pressure contact blade being fixed to the clamping main body and being capable of being connected to an outer conductor of the coaxial cable, and a grounding portion being fixed to the clamping main body under a state in which grounding portion is electrically coupled to the pressure contact blade and being capable of grounding the outer conductor of the coaxial cable to a grounded portion, wherein the clamping main body is configured to clamp a plurality of coaxial cables, and under a state in which the clamping main body clamps the plurality of coaxial cables, the outer conductors of all the plurality of coaxial cables clamped by the clamping main body are electrically connected to the grounding portion via the pressure contact blade.

According to the present application, it is possible to provide a coaxial cable clamping member capable of grounding a plurality of coaxial cables more easily.

### BRIEF DESCRIPTION OF DRAWINGS

FIG. 1 is a perspective view illustrating a structure in which a plurality of coaxial cables are held by using an example of a coaxial cable clamping member according to the present embodiment.

FIG. 2 is a cross-sectional view illustrating a state in which outer conductors of the plurality of coaxial cables are grounded to a grounded member by using an example of the coaxial cable clamping member according to the present embodiment.

FIG. 3 is a cross-sectional view illustrating a state in which the outer conductors of the plurality of coaxial cables are grounded to the grounded member by using a coaxial cable clamping member in a first modification example.

FIG. 4 is a cross-sectional view illustrating a state in which the outer conductors of the plurality of coaxial cables are grounded to the grounded member by using a coaxial cable clamping member in a second modification example.

### DETAILED DESCRIPTION OF THE INVENTION

With reference to the drawings, a coaxial cable clamping member according to this embodiment is described below in detail.

Description is given below while defining a vertical direction under a state in which a metal plate (grounded portion) is positioned on the lower side and the coaxial cable clamping member is positioned on the upper side.

Further, similar constituent elements are included in a plurality of embodiments and modification examples thereof that are given below. Thus, in the following description, the similar constituent elements are denoted with commonly-shared reference symbols, and overlapping description is omitted.

### First Embodiment

A coaxial cable clamping member 10 according to the present embodiment is configured to collectively clamp a plurality of coaxial cables 50. In other words, the coaxial cable clamping member 10 according to the present embodiment being one member is capable of simultaneously clamping the plurality of coaxial cables 50 that are independent from each other. Further, when the coaxial cable clamping member 10 clamps the plurality of coaxial cables 50, a coaxial cable clamping structure 1 is formed.

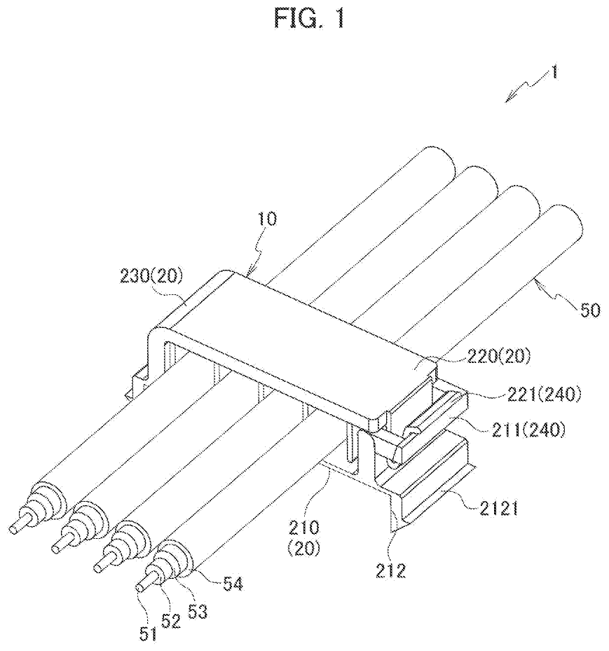

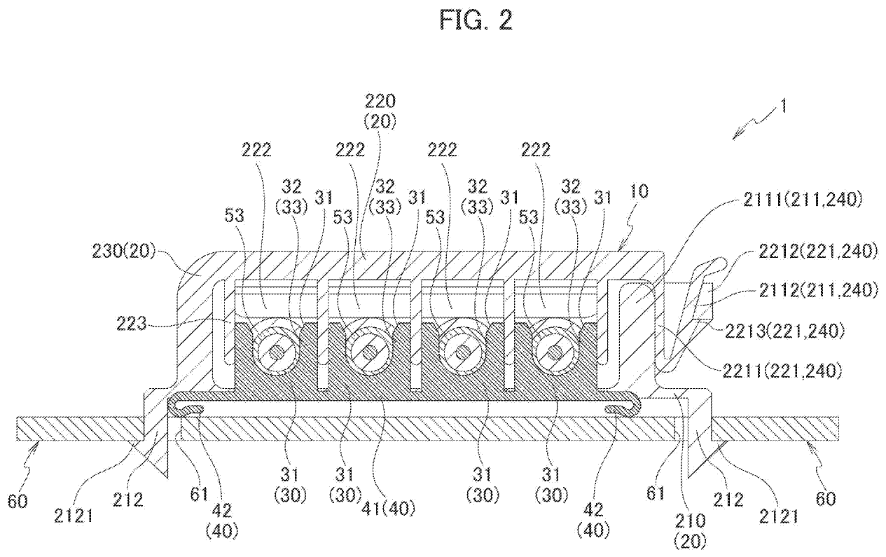

Note that, as illustrated in FIG. 1 and FIG. 2, in the present embodiment, the coaxial cable clamping member 10 capable of clamping four coaxial cables 50 at the same time is illustrated, but the configuration is not limited thereto. In other words, the coaxial cable clamping member may clamp two, three, five, or more coaxial cables 50 at the same time.

Note that the coaxial cable 50 is used for an antenna cable, a communication transmission path, or the like, and includes an inner conductor 51 being a core wire arranged at the center portion and an inner insulation layer 52 being a dielectric provided to a periphery of the inner conductor 51. Further, the coaxial cable 50 includes an outer conductor 53 being a shielding layer provided to a periphery of the inner insulation layer 52 and an outer insulation layer 54 provided to a periphery of the outer conductor 53. The outer insulation layer 54 includes a function as a protection layer for protecting the outer conductor 53.

Further, in the present embodiment, the coaxial cable clamping member 10 includes a clamp main body 20 capable of clamping the plurality of coaxial cables 50 that are arrayed in the width direction. The clamp main body 20 may be formed by using a material such as a synthetic resin.

The clamp main body 20 includes a first clamp portion 210 and a second clamp portion 220, and the plurality of coaxial cables 50 is clamped between the first clamp portion 210 and the second clamp portion 220.

Here, in the present embodiment, the first clamp portion 210 and the second clamp portion 220 are coupled to each other via a hinge that is formed on one end side in the width direction, and the second clamp portion 220 is turnable relatively to the first clamp portion 210 with the hinge 230 as a base point. In other words, the second clamp portion 220 is configured to be turnable relatively to the first clamp portion 210 between an opened state in which the plurality of coaxial cables 50 are not clamped and a closed state in which the plurality of coaxial cables 50 are clamped.

Further, on the other end side of the first clamp portion 210 and the second clamp portion 220 in the width direction, a lock portion 240 capable of performing a lock in the closed state is formed. In other words, on the other end side of the first clamp portion 210 and the second clamp portion 220 in the width direction, the lock portion 240 capable of maintaining the state in which the plurality of coaxial cables 50 are clamped is formed.

In the present embodiment, the lock portion 240 includes an engaging portion 221 and an engaged portion 211. The engaging portion 221 is formed on the other end side of the second clamp portion 220 in the width direction. The engaged portion 211 is formed on the other end side of the first clamp portion 210 in the width direction, and is releasably engaged with the engaging portion 221.

Specifically, the engaging portion 221 includes an extension wall 2211 that is provided to extend downward (toward the first clamp portion 210) and an arm portion 2212 that is provided to extend upward from the lower end of the extension wall 2211 and outward in the width direction. The arm portion 2212 is elastically deformable in the width direction while a coupling portion with the extension wall 2211 functions as a base point. Moreover, the engaging portion 221 includes a hook portion 2213 that is formed at the center portion of the arm portion 2212 in the vertical direction to protrude outward in the width direction and is engaged with the engaged portion 211.

Meanwhile, the engaged portion 211 includes an extension wall 2111 that is provided to extend upward (toward the second clamp portion 220) and an engagement frame 2112 that is continuously provided outward in the width direction at the upper end of the extension wall 2111. The hook portion 2213 is releasably hung on the engagement frame 2112.

Further, the coaxial cable clamping member 10 includes a pressure contact blade 33 that is fixed to the clamping main body 20 and is capable of being electrically coupled to the outer conductor 53 of the coaxial cable 50.

In the present embodiment, the coaxial cable clamping member 10 includes four (plurality of) cable holders 30, and the one coaxial cable 50 is temporarily held by each of the cable holders 30 when the clamping main body 20 clamps the plurality of coaxial cables Specifically, the four (plurality of) cable holders 30 are formed of a material having electrical conductivity such as metal, and are fixed to the first clamping portion 210 under a state in which the four (plurality of) cable holders 30 are separated from each other.

Further, the four (plurality of) cable holders 30 include main body portions 31, respectively, and a cable holding groove 311 that is opened upward is formed in each of the main body portions 31. Further, when the coaxial cable 50 is temporarily held by the cable holder 30, the coaxial cable 50 is inserted into the cable holding groove 311.

Moreover, in the present embodiment, a blade portion 32 is formed at the peripheral edge portion of the cable holding groove 311 of each of the main body portions 31. Further, when the clamping main body 20 clamps the plurality of coaxial cables 50, the blade portion 32 passes through the outer insulation layer 54 to contact with the outer conductor 53.

As described, in the present embodiment, the blade portion 32 formed in each of the cable holders 30 functions as the pressure contact blade 33.

Moreover, the coaxial cable clamping member 10 includes a grounding portion 42 fixed to the clamping main body 20 under a state in which the grounding portion 42 is electrically connected to each of the blade portions 32 (the pressure contact blades 33). In the present embodiment, the grounding portion 42 is formed on a grounding jumper 40 formed by a material having electrical conductivity such as metal. Further, the grounding jumper 40 is fixed to the first clamping portion 210, and thus the grounding portion 42 is fixed to the first clamping portion 210.

In the present embodiment, the grounding jumper 40 includes a coupling portion 41 that extends elongatedly in the width direction and has an upper end to which the lower ends of the four (plurality of) cable holders 30 are continuously provided and the pair of grounding portions 42 that are formed on both the ends in the width direction of the lower end of the coupling portion 41. In other words, the four (plurality of) cable holders 30 and the one grounding jumper 40 are formed as one member having electrical conductivity. In this manner, all the blade portions 32 and all the grounding portions 42 are electrically connected to each other via the coupling portions, and all the coaxial cables 50 are electrically connected to the grounding portion 42 via the blade portion 52.

Note that, in the present embodiment, the grounding jumper 40 is fixed to the first clamping portion 210 under a state in which the grounding portion 42 is exposed downward. Such a configuration may be formed by insert molding, for example.

Further, as illustrated in FIG. 2, the grounding portion 42 that is exposed downward is brought into contact with a metal plate (grounded portion) 60, and thus the outer conductors 53 of all the coaxial cables 50 that are clamped by the clamping main body 20 are grounded to the metal plate (grounded portion) 60. Note that the grounding portion 42 may be connected to a circuit pattern (for example, a ground pattern or the like) formed on a printed circuit board (grounded portion), and thus the outer conductors 53 of all the coaxial cables 50 may be grounded.

In the present embodiment, a fixing portion 212 is formed to protrude downward on each side in the width direction of the lower end of the first clamping portion 210, and a hook portion 2121 that protrudes outward in the width direction is formed at the lower end of the fixing portion 212. Further, the fixing portion 212 is inserted into an engagement hole 61 from above, which is formed in the metal plate (grounded portion) 60, and thus the hook portion 2121 is hung on the lower surface of the metal plate (grounded portion) 60. In this manner, the coaxial cable clamping member 10 that clamps the plurality of coaxial cables 50 is fixed to the metal plate (grounded portion) 60. In this state, the grounding portions 42 are brought into contact with the upper side of the metal plate (grounded portion) 60. In this manner, in the present embodiment, the coaxial cable clamping member 10 that clamps the plurality of coaxial cables 50 is fixed to the metal plate 60, and thus the outer conductors 53 of all the coaxial cables 50 that are clamped by the clamping main body 20 are grounded to the metal plate 60.

Further, a cable retainer 222 is formed at a position of the lower end of the second clamping portion 220, which corresponds to each of the coaxial cables 50, and the cable retainer 222 performs pressing by pressing down the coaxial cable 50 when the clamping main body 20 clamps the plurality of coaxial cables 50. Note that, under a state in which the clamping main body 20 clamps the plurality of coaxial cables 50, each of the coaxial cables 50 is pressed by the corresponding cable retainer 222.

Moreover, in the present embodiment, at the lower end of the second clamping portion 220, a partition wall 223 that partitions the plurality of coaxial cables 50 from each other is formed. Further, the partition wall 223 is provided, and thus the partition wall 223 can suppress movement of the coaxial cable 50 in the horizontal direction (the width direction) when the clamping main body 20 clamps the plurality of coaxial cables 50. In other words, when the clamping main body 20 clamps the plurality of coaxial cables 50, the coaxial cable 50 is guided by the partition wall 223, and is pressed downward by the cable retainer 222. Note that, when the first clamping portion 210 and the second clamping portion 220 are coupled with each other via the hinge 230 as in the present embodiment, it is preferred that interference between the partition wall 223 and the cable holder 30 be suppressed at the time of opening and closing the second clamping portion 220. Such a configuration may be achieved by, for example, absence of the partition wall 223 in the vicinity of the cable holder 30 under a state in which the second clamping portion 220 is closed. Further, such a configuration may also be achieved by forming the partition wall 223 so that the protrusion amount thereof is reduced as approaching the hinge 230.

The coaxial cable clamping structure 1 using the coaxial cable clamping member 10 thus configured may be formed by the following method, for example.

First, the second clamping portion 220 turns relatively to the first clamping portion 210 in an opening direction, and thus the opened state is obtained. Subsequently, the four (plurality of) coaxial cables 50 are temporarily held by the cable holders 30, respectively. Further, under a state in which the four (plurality of) coaxial cables 50 are temporarily held by the cable holders 30, respectively, the second clamping portion 220 turns relatively to the first clamping portion 210 in the opening direction, and thus the engaging portion 221 is engaged and locked with the engaged portion 211. In this state, each of the coaxial cables 50 is guided by the partition wall 223 and is pressed downward by the cable retainer 222, and then the blade portion 32 penetrates the outer insulation layer 54 and is brought into contact with the outer conductor 53.

In this manner, under a state in which the outer conductors 53 are electrically coupled to the grounding portion 42, all the four (plurality of) coaxial cables 50 are clamped by the coaxial cable clamping member 10, and thus the coaxial cable clamping structure 1 is formed.

Further, under a state in which the coaxial cable clamping structure 1, the coaxial cable clamping member 10 is fixed to the metal plate (grounded portion) 60, and thus all the outer conductors 53 of the four (plurality of) coaxial cables 50 are grounded to the metal plate (grounded portion) 60.

In this manner, when the coaxial cable clamping member 10 according to the present embodiment is used, the plurality of coaxial cables 50 can be grounded to the metal plate (grounded portion) 60 more easily.

### Frist Modification Example

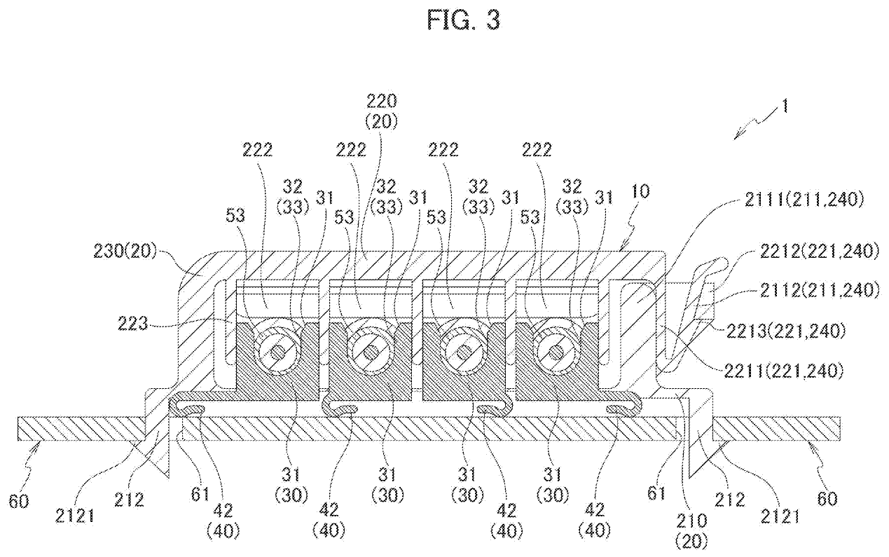

Note that the shape of the coaxial cable clamping member is not limited to the shape described in the embodiment described above, and various shapes may be adopted. For example, the coaxial cable clamping member 10 illustrated in FIG. 3 may be achieved.

The coaxial cable clamping member 10 illustrated in FIG. 3 is also configured similarly to the coaxial cable clamping member 10 described in the embodiment described above.

In other words, the coaxial cable clamping member 10 illustrated in FIG. 3 also includes the clamping main body 20 that is capable of clamping the coaxial cable 50 and the pressure contact blade 33 that is fixe to the clamping main body 20 and is capable of being electrically connected to the outer conductor 53 of the coaxial cable 50. Further, the coaxial cable clamping member 10 illustrated in FIG. 3 also includes the grounding portion 42 that is fixed to the clamping main body 20 under a state in which the grounding portion 42 is electrically connected to the pressure contact blade 33 and is capable of grounding the outer conductor 53 of the coaxial cable 50 to the metal plate (grounded portion) 60.

In the coaxial cable clamping member 10 illustrated in FIG. 3, the clamping main body 20 is also configured to clamp the plurality of coaxial cables 50. Further, under a state in which the clamping main body 20 clamps the plurality of coaxial cables 50, the outer conductors 53 of all the coaxial cables 50 that are clamped by the clamping main body 20 are electrically connected to the grounding portion 42 via the pressure contact blade 33.

Further, in the coaxial cable clamping member 10 illustrated in FIG. 3, the clamping main body 20 also includes the first clamping portion 210 and the second clamping portion 220. Further, the first clamping portion 210 and the second clamping portion 220 are coupled to each other via the hinge 230, and the first clamping portion 210 and the second clamping portion 220 are capable of collectively clamping the plurality of coaxial cables 50.

Further, in the coaxial cable clamping member 10 illustrated in FIG. 3, the coaxial cable clamping member 10 also includes the plurality of cable holders 30 each of which is fixed to the clamping main body 20 under a state in which the plurality of cable holders 30 are separated from each other and is capable of temporarily holding the one coaxial cable 50. Moreover, in the coaxial cable clamping member 10 illustrated in FIG. 3, the pressure contact blade 33 also includes the blade portion 32 provided to each of the cable holders 30.

Here, in the coaxial cable clamping member 10 illustrated in FIG. 3, the grounding portion 42 is formed in each of the cable holders 30. Further, under a state in which the coaxial cable clamping structure 1 is formed, when the coaxial cable clamping member 10 is fixed to the metal plate (grounded portion) 60, all the grounding portions 42 are brought into contact with the metal plate (grounded portion) 60. Note that the plurality of grounding portions 42 may be grounded to a plurality of circuit patterns (for example, ground patterns or the like) formed on a printed circuit board (grounded portion), respectively, and thus the outer conductors 53 of all the coaxial cables 50 may be grounded.

The coaxial cable clamping member thus configured can also exert actions and effects that are substantially the same as the coaxial cable clamping member 10 described in the embodiment described above.

### Second Modification Example

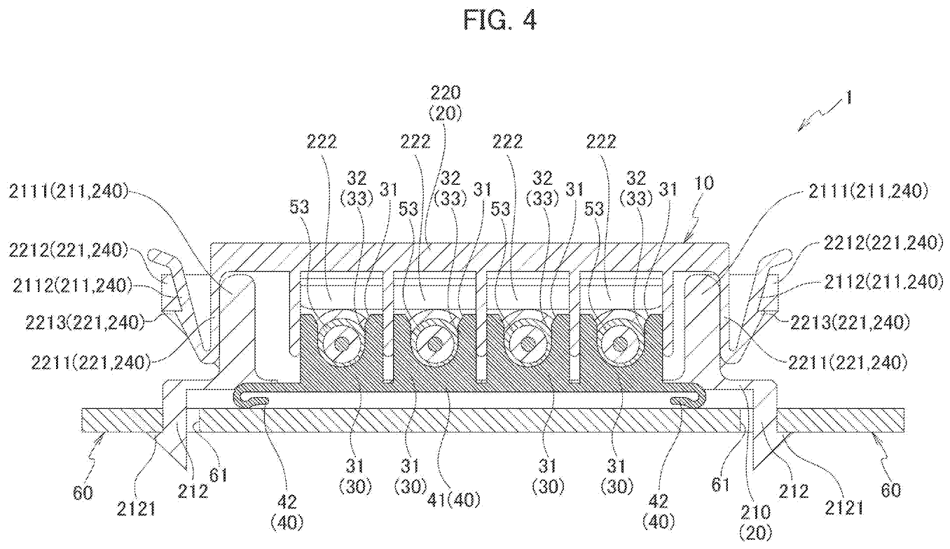

Further, the coaxial cable clamping member 10 illustrated in FIG. 4 may be achieved.

The coaxial cable clamping member 10 illustrated in FIG. 4 is also configured similarly to the coaxial cable clamping member 10 described in the embodiment described above.

In other words, the coaxial cable clamping member 10 illustrated in FIG. 4 also includes the clamping main body 20 that is capable of clamping the coaxial cable 50 and the pressure contact blade 33 that is fixe to the clamping main body 20 and is capable of being electrically connected to the outer conductor 53 of the coaxial cable 50. Further, the coaxial cable clamping member 10 illustrated in FIG. 4 also includes the grounding portion 42 that is fixed to the clamping main body 20 under a state in which the grounding portion 42 is electrically connected to the pressure contact blade 33 and is capable of grounding the outer conductor 53 of the coaxial cable 50 to the metal plate (grounded portion) 60. Note that, even when the coaxial cable clamping member 10 illustrated in FIG. 4 is used, the grounding portion 42 is connected to a circuit pattern such as a ground pattern formed on a printed circuit board (grounded portion), and thus the outer conductors 53 of all the coaxial cables can be grounded.

Further, in the coaxial cable clamping member 10 illustrated in FIG. 4, the clamping main body 20 is also configured to clamp the plurality of coaxial cables 50. Further, under a state in which the clamping main body 20 clamps the plurality of coaxial cables 50, the outer conductors 53 of all the coaxial cables 50 that are clamped by the clamping main body are electrically connected to the grounding portion 42 via the pressure contact blade 33.

Further, in the coaxial cable clamping member 10 illustrated in FIG. 4, the clamping main body 20 also includes the first clamping portion 210 and the second clamping portion 220.

Further, in the coaxial cable clamping member 10 illustrated in FIG. 4, the coaxial cable clamping member 10 also includes the plurality of cable holders 30 each of which is fixed to the clamping main body 20 under a state in which the plurality of cable holders 30 are separated from each other and is capable of temporarily holding the one coaxial cable 50. Moreover, in the coaxial cable clamping member 10 illustrated in FIG. 4, the pressure contact blade 33 also includes the blade portion 32 provided to each of the cable holders 30, and all the blade portions 32 are electrically connected to the grounding portion 42 via the coupling portion 41.

Here, in the coaxial cable clamping member 10 illustrated in FIG. 4, the first clamping portion 210 and the second clamping portion 220 are formed as separate bodies. Further, the lock portion 240 capable of performing a lock in the closed state is formed on either side of the first clamping portion 210 and the second clamping portion 220 in the width direction.

In this manner, when the coaxial cable clamping structure 1 is formed, the second clamping portion 220 is caused to relatively move downward with respect to the first clamping portion 210 under a state in which the plurality of coaxial cables 50 are temporarily held on the first clamping portion 210.

The coaxial cable clamping member thus configured can also exert actions and effects that are substantially the same as the coaxial cable clamping member 10 described in the embodiment described above.

### Actions and Effects

Characteristic configurations of the coaxial cable clamping member illustrated in the embodiment and the modification examples thereof that are described above and effects exerted therefrom are described below.

The coaxial cable clamping member 10 illustrated in the embodiment and the modification examples thereof that are described above includes the clamping main body 20 that is capable of clamping the coaxial cable 50 and the pressure contact blade 33 that is fixed to the clamping main body 20 and is capable of being electrically connected to the outer conductor 53 of the coaxial cable 50. Further, the coaxial cable clamping member 10 includes the grounding portion 42 that is fixed to the clamping main body 20 under a state in which the grounding portion 42 is electrically connected to the pressure contact blade 33 and is capable of grounding the outer conductor 53 of the coaxial cable 50 to the metal plate (grounded portion) 60.

Here, the clamping main body 20 is configured to collectively clamp the plurality of coaxial cables 50.

Further, under a state in which the clamping main body 20 clamps the plurality of coaxial cables 50, the outer conductors 53 of all the coaxial cables 50 that are clamped by the clamping main body 20 are electrically connected to the grounding portion 42 via the pressure contact blade 33.

The coaxial cable clamping member 10 thus configured is used to clamp the plurality of coaxial cables 50, and thus the outer conductors 53 of the plurality of coaxial cables 50 can be electrically connected to the grounding portion 42 at the same time. Further, when the outer conductors 53 of the plurality of coaxial cables 50 are electrically connected to the grounding portion 42, the outer conductors 53 of the plurality of coaxial cables 50 can be collectively grounded to the metal plate 60 simply by grounding the grounding portion 42 to the metal plate 60.

In this manner, when the coaxial cable clamping member 10 illustrated in the embodiment and the modification examples thereof that are described above is used, the plurality of coaxial cables 50 can be grounded to the metal plate (grounded portion) 60 more easily.

Further, the clamping main body 20 may include the first clamping portion 210 and the second clamping portion 220 that is coupled to the first clamping portion 210 via the hinge 230 and is capable of collectively clamping the plurality of coaxial cables 50 with the first clamping portion 210.

With this, a work for clamping the plurality of coaxial cables 50 by the clamping main body 20 is facilitated, and hence the plurality of coaxial cables 50 can be grounded to the metal plate (grounded portion) 60 further more easily.

Further, the coaxial cable clamping member 10 may include the plurality of cable holders 30 each of which is fixed to the clamping main body 20 under a state in which the plurality of cable holders 30 are separated from each other and is capable of temporarily holding the one coaxial cable 50. Further, the pressure contact blade 33 may include the blade portion 32 that is provided to each of the cable holders 30, and all the blade portions 32 may be electrically connected to the grounding portion 42 via the coupling portion 41.

In this manner, when the plurality of coaxial cables 50 are temporarily held by the cable holders 30 that are formed individually, the outer conductor 53 of the coaxial cable 50 can be electrically connected to the blade portion 32 more securely at the time of clamping by the clamping main body 20. Further, when each of the blade portions 32 is electrically connected to the grounding portion 42 via the coupling portion 41, presence of the coaxial cable 50 that is not grounded to the metal plate (grounded portion) 60 can be suppressed more securely. Therefore, the outer conductors 53 of all the coaxial cables 50 that are clamped by the clamping main body 20 can be grounded to the metal plate (grounded portion) 60 more securely.

### [Others]

The present embodiment is described above. However, the present embodiment is not limited thereto, and various modifications may be made within the gist of the present embodiment.

For example, a configuration may be obtained as appropriate by combining the configurations described in the embodiment and the modification examples thereof that are described above.

Further, in the embodiment and the modification examples thereof that are described above, the state in which the cable holders 30 are formed individually is illustrated, but the plurality of coaxial cables 50 may be temporarily held by the one cable holder 30.

Further, in the embodiment and the modification examples thereof that are described above, the state in which the partition wall 223 is provided to the second clamp portion 220 is illustrated, but the partition wall may be provided to the first clamp portion 210. Further, the partition wall may be a separate body from the first clamp portion 210 and the second clamp portion 220, or a configuration in which a partition wall is not provided may be adopted.

Further, specifications (shapes, sizes, layouts, and the like) of the clamping main body, the pressure contact blade, and the other detailed portions may be changed as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A coaxial cable clamping member, comprising:
a clamping main body capable of clamping a coaxial cable;
a pressure contact blade being fixed to the clamping main body and being capable of being connected to an outer conductor of the coaxial cable; and
a grounding portion being fixed to the clamping main body under a state in which grounding portion is electrically coupled to the pressure contact blade and being capable of grounding the outer conductor of the coaxial cable to a grounded portion, wherein
the clamping main body is configured to clamp a plurality of coaxial cables,
under a state in which the clamping main body clamps the plurality of coaxial cables, the outer conductors of all the plurality of coaxial cables clamped by the clamping main body are electrically connected to the grounding portion via the pressure contact blade, and
the coaxial cable clamping member further comprises a plurality of cable holders each of which is fixed to the clamping main body under a state in which the plurality of cable holders are separated from each other and is capable of temporarily holding one coaxial cable,
the clamping main body includes:
a first clamping portion to which the plurality of cable holders are fixed; and
a second clamping portion capable of collectively clamping the plurality of coaxial cables with the first clamping portion,
a blade portion provided to each of the plurality of cable holders functions as the pressure contact blade, and
a cable retainer for performing a pressing by pressing the coaxial cable at the time of clamping the plurality of coaxial cables and a partition wall for partitioning the plurality of coaxial cables from each other are formed in the second clamping portion.

2. The coaxial cable clamping member according to claim 1, wherein
the first clamping portion and the second clamping portion are coupled to each other via a hinge.

3. The coaxial cable clamping member according to claim 1, wherein
all blade portions are electrically connected to the grounding portion via a coupling portion.
